(19) United States
(12) Patent Application Publication
(10) Pub. No.: US 2007/0106017 A1
(43) Pub. Date: May 10, 2007

(54) Energy-curable coating compositions

(75) Inventors: Stewart Kessel, Kent (GB); James F. Welch, Kent (GB)

Correspondence Address: DICKSTEIN SHAPIRO, 1177 AVENUE OF THE AMERICAS (6TH AVENUE), NEW YORK, NY, 10036-2714, US

(73) Assignee: Sun Chemical Corporation, Parsippany, NJ (US)

(21) Appl. No.: 10/579,612

(22) PCT Filed: Oct. 14, 2004
(86) PCT No.: PCT/US04/34040

§ 371 Date: Dec. 26, 2006

(30) Foreign Application Priority Data
Oct. 17, 2003 (GB) 0324355.7

(51) Int. Cl. C08G 18/08

(52) U.S. Cl. 524/589

(57) ABSTRACT

An energy-curable coating composition comprises a water-soluble or water-dispersible binder capable of being poly-merised by exposure to a source of radiation, a particulate electrically conductive material, and water as a non-reactive diluent, and, if necessary, a photoinitiator, the composition, when cured, having a resistivity no greater than 1 ohm/square, as measured by ASTM F1896-98. The cured product can be used as a conductive coating or ink for use in such applications as RFID tags.

The present invention relates to novel energy-curable coating compositions containing an electrically conductive component (often referred to as an electrically conductive filler or pigment, regardless whether that component does or does not impart a colour to the composition) and having sufficient conductivity that, when cured, the resultant coating can be used as a conductive element (as opposed to a resistive element) of a printed circuit. This implies a resistivity of less than 1 ohm/square, and preferably less than 10⁻¹ ohm/square (when measured by the method defined by ASTM test method F1896-98, “Test Method For Determining The Electrical Resistivity Of A Printed Conductive Material”). Such compositions are suitable for use in the printed construction of articles such as RFID (radio frequency identification) tag antennae, membrane switch circuitry, and medical diagnostic devices. Depending upon the intended use of the composition, it may be formulated as an ink, varnish or other form of coating composition.

In the present specification, when we refer to “conductive”, we mean, unless the context requires otherwise, that the material concerned has sufficient conductivity (or a sufficiently low resistivity) that it may be used for the purposes referred to in the preceding paragraph.

By “energy cure systems” or “energy cure compositions”, as used herein, we mean systems or compositions that are free-radically polymerisable or crosslinkable by exposure to a source of actinic radiation such as ultraviolet (UV), or electron beam (EB) radiation.

Hitherto conductive inks and coatings have primarily been based on solvent- or water borne-thermal evaporative drying or on two-component chemical cross-linkable technology. (In this field, the word “solvent”, when used in relation to inks and the like, normally implies an organic solvent, rather than water). Typically these compositions have high conductivity, but are slow drying and are not suitable for use with web-fed high speed printing presses, such as rotary screen presses. Also, thermal evaporation drying systems are not suitable for heat sensitive substrates, where problems with substrate distortion would give rise to problems such as poor print registration. Environmental legislative pressure also means that there is a desire to move away from the use of solvent borne products. Many attempts have, therefore, been made to provide an alternative to this technology which does not exhibit the same disadvantages.

It is well known that energy cure systems are environmentally advantageous and typically yield improved productivity. There have, as a result, been several proposals for so-called solventless coating compositions containing electrically conductive fillers or pigments Typical of these are the materials described in EP0653763A1, U.S. Pat. No. 4,999,136, U.S. Pat. No. 5,514,729, U.S. Pat. No. 6,290,881, WO93/24934 and WO01/45936. However, existing energy cure conductive ink systems typically have significantly higher resistivity and reduced conductivity values compared to solvent or water borne evaporation drying products. This is because the conductivity of the dried ink coating is a function of the conductive filler or pigment content in relation to the binder content. With conventional energy cure systems, there is little shrinkage of the printed film during cure, unlike with solvent or water borne thermal evaporation drying systems where the evaporation of the volatile material increases the effective conductive filler or pigment to binder ratio. Therefore, in order to achieve improved conductivity in conventional energy cure systems, increased conductive pigment loadings are required. However, this increases the cost of the system and has a significant effect on the rheology and hence printability of the composition. Thus, in order to achieve a sufficiently low viscosity that the composition can be printed, compromises have to be made in the choice of components, often requiring the inclusion of materials intended to improve the rheology of the composition at the expense of the properties of the final cured product. If such compromises are not made, this leads to poor printability due to inferior rheology, especially high viscosity. Increased conductive filler or pigment loadings will also result in poor cure efficiency, again not lending itself to high productivity. Poor adhesion at high pigment loadings can also be an issue. This restricts the suitability of the prior art materials as potential replacements for solvent and water borne systems, and limits their suitability for high speed presses.

A common method used to improve the conductivity of conventional energy cure systems is to follow the energy cure with a thermal heating cycle, such as disclosed in W093/24934. However, this additional processing reduces productivity and is not suitable for use with heat sensitive substrates.

We have now surprisingly discovered that the use of water-containing energy cure technology can resolve the problems of the prior art and enable the production of conductive inks which give good print definition and adhesion, and which can be applied easily by a high speed printing process.

It is known that conventional conductive inks, when printed, dried and then compressed under high pressure, show improved conductance of the print as compared with identical inks which have not been so compressed. We have surprisingly found that this effect is significantly more pronounced with the coating compositions of the present invention.

Certain UV water-borne conductive coating compositions have previously been proposed, although for other purposes and with a much lower conductivity (higher resistivity), for example U.S. Pat. No. 4,322,331, and U.S. Pat. No. 4,420,541. However, these are intended for use as anti-static coatings and use an aqueous solution of a quaternary arnrnonium salt to provide the conductivity. This results in significantly higher resistivity values in the order of 10³ to 10⁷ ohm/square, which would not be suitable for articles of the type for which the compositions of the present invention are intended to be used.

Unfortunately, good conductivity is not the sole requirement for a useful conductive coating such as an ink. Such compositions need good print definition, i.e. they should be able to resolve e.g. 100 micron lines. They also need good adhesion to a range of different potential substrates, e.g. print receptive polyester, polycarbonate, coated and uncoated paper/board stocks and polyimide substrates. In addition, if they are to be printed onto a flexible substrate, which is ofen desirable for a RFID tag, then they need to be flexible.

Thus, the present invention consists in an energy-curable coating composition comprising a water-soluble or water-dispersible binder capable of being polymerised by exposure to a source of radiation, a particulate electrically conductive material, and water as a non-reactive diluent, and, if necessary, a photoinitiator, the composition, when cured, having a resistivity no greater than 1 ohm/square, as measured by ASTM F1896-98.

Preferably, the energy-curable binder comprises at least a polymerisable monomer, prepolymer or oligomer capable of polymerisation by exposure to a source of radiation and including at least one component which is water-soluble or water-dispersible. More preferably, the composition comprises a water-soluble or water-dispersible oligomer or prepolymer capable of being polymerised by radiation and/or a water-soluble monomer capable of being polymerised by radiation, and optionally a water-insoluble monomer capable of being polymerised by radiation.

Still more preferably, the composition comprises:
(a) a water-soluble or water-dispersible oligomer or prepolymer capable of being polymerised by radiation,
(b) a water-soluble monomer capable of being polymerised by radiation,
(c) a water-insoluble monomer capable of being polymerised by radiation,
(d) a particulate electrically conductive material,
(e) water as a solvent or dispersant, and
(f) optionally a photoinitiator,
   the composition, when cured, having a resistivity no greater than 1 ohm/square, as measured by ASTM F1896-98.

The invention further comprises a process for producing a printed electrically conductive coating, e.g. a printed circuit, preferably a RFID circuit, in which a composition of the present invention is printed onto a substrate, and is then energy cured by exposure to a source of actinic radiation, e.g. UV or electron beam radiation.

A composition which dries solely by evaporation of a solvent, as in the prior art water-borne inks, will shrink during cure, thus giving improved conductivity through compaction of the conductive o particles in the dried ink film. However, a composition which cures solely by polymerisation does not undergo the same degree of shrinkage and so requires a higher loading of conductive material in order to achieve comparable conductivity. By combining these disparate technologies, we have achieved the advantages of both, with good conductivity at relatively low conductive material loadings.

The oligomer or prepolymer (a) should be capable of being polymerised by radiation and should be soluble or dispersible in water. It is preferably a water-soluble or water-dispersible urethane, polyester, polyether or epoxy resin containing acrylate or methacrylate ester groups and/or residues, for example an aliphatic or aromatic urethane (meth)acrylate, polyether (meth)acrylate, polyester (meth)acrylate or epoxy (meth)acrylate. The polymer preferably has a molecular weight of from 800 to 3000 and more preferably from 1000 to 2000. The proportions of the polymerisable components of the composition of the present invention are not critical. However, the polymerisable oligomer or prepolymer (a) is preferably present in the coating composition in an amount of from 2 to 15%, more preferably from 4 to 14% by weight, and more preferably from 5 to 12% by weight of the total composition.

Specific examples of commercially available water-soluble or dispersible prepolymers and oligomers include: CD9038 [ethoxylated (30) bisphenol A diacrylate], SR9036 [ethoxylated (30) bisphenol A dimethacrylate], CN132 [low viscosity diacrylate oligomer] and CN133 low viscosity triacrylate oligomer), all ex Sartomer; EBECRYL 2001 [aliphatic urethane diacrylate, contains 5% water], EBECRYL 2002 [aliphatic urethane diacrylate, contains 10% TPGDA], EBECRYL 2004 [aliphatic urethane triacrylate, contains 20% HDDA], EBECRYL 2100 [aliphatic urethane diacrylate, contains 50% water], UCECOAT DW 7524 [aliphatic/acrylic hybrid dispersion], UCECOAT DW 7720 [aromatic dispersion], UCECOAT DW 7770 [aliphatic dispersion], UCECOAT DW 7772 [aliphatic dispersion], UCECOAT DW 7773 [aliphatic dispersion], UCECOAT DW 7822 [aliphatic dispersion], UCECOAT DW 7825 [aliphatic dispersion], UCECOAT DW 7849 [aliphatic dispersion], UCECOAT DW 7900 [aliphatic dispersion], Viaktin VTE 6155 w/50WA [water borne urethane acrylate dispersion], Viaktin VTE 6165 w/48WA [water bome urethane acrylate dispersion], Viaktin VTE 6169 w/45WA [water borne urethane acrylate dispersion], Viaktin VTE 6177 w/40WA [water borne urethane acrylate dispersion], all ex UCB; Laromer PE 55 W [polyester acrylate dispersion], Laromer LR 8895 [urethane acrylate dispersion], Laromer LR 8949 [urethane acrylate dispersion], Laromer LR 8983 [urethane acrylate dispersion], Laromer LR 8765 [epoxy acrylate], Laromer LR 8982 [polyether acrylate], all ex BASF; Ur. Ac. 98-283W [polyurethane acrylate dispersion], ex Rahn; and LUX 101 [radiation curable, aqueous aliphatic polyurethane emulsion], LUX 102 [radiation curable, aqueous polyurethane and acrylate emulsions], LUX 121 [radiation curable, aqueous polyurethane and acrylate emulsions], LUX 241 [radiation curable, aqueous polyurethane and acrylate emulsions], LUX 296 [radiation curable, aqueous polycarbonate-urethane emulsion], LUX 308 [radiation curable, aqueous polyurethane and acrylate emulsions], LUX 338 [radiation curable, aqueous polyurethane and acrylate emulsions], LUX 352 [radiation curable, aqueous polyurethane and acrylate emulsions], LUX 390 [radiation curable, aqueous polyurethane and acrylate emulsions], LUX 399 [radiation curable, aqueous polyurethane and acrylate emulsions], LUX 584 [radiation curable, aqueous acrylate emulsion], LUX 822 [radiation curable, aqueous polyurethane and acrylate emulsions], LUX 860 [radiation curable, aqueous polyurethane and acrylate emulsions], LUX 941 [radiation curable, aqueous polyurethane and acrylate emulsions], AC2571 [radiation curable, aqueous polyurethane and acrylate emulsions], all ex Alberdingk Boley.

The water soluble monomer (b) should likewise be capable of being polymerised by radiation and should be soluble in water. It is normally an ethylenically unsaturated compound. Examples of suitable acrylate monomers include esters of acrylic or methacrylic acid with polyethylene glycol or with a mono-, di-, tri-, or tetra- hydric alcohol derived by ethoxylating a mono-, di, tri-, or tetra-hydric aliphatic alcohol of molecular weight less than 200 with ethylene oxide. Examples of these are acrylate esters of polyethylene glycols made from a polyethylene glycol preferably having a molecular weight of from 200 to 1500, more preferably from 400 to 1000, and most preferably from 400 to 800; and acrylic esters of ethoxylated trimethylolpropane, preferably having from 9 to 30 ethoxylate residues, more preferably from 10 to 20 ethoxylate residues. The proportion of the water-soluble monomer is also not critical, but it is preferably present in an amount of from 2 to 10%, more preferably from 2 to 9% by weight, and most preferably from 3 to 8% by weight, of the total composition.

Specific examples of commercially available water-soluble or dispersible monomers include: SR415 [ethoxylated (20) trimethylolpropane triacrylate], SR705 [metallic diacrylate], SR9016 [metallic diacrylate], SR708 [metallic dimethacrylate], CD550 [methoxy polyethylene glycol (350) monomethacrylate], CD552 [methoxy polyethylene glycol (550) monomethacrylate], SR259 [polyethylene glycol (200) diacrylate], SR344 [polyethylene glycol (400) diacrylate], SR603 [polyethylene glycol (400) dimethacrylate], SR610 [polyethylene glycol (600) diacrylate], SR252 [polyethylene glycol (600) dimethacrylate], SR604 [polypropylene glycol monomethacrylate, and SR256 [2-(2-ethoxyethoxy)ethyl acrylate], SR9035 [ethoxylated (15) trimethylolpropane triacrylate], all ex Sartomer; EBECRYL 11 [polyethylene glycol diacrylate], and EBECRYL 12 [polyether triacrylate], both ex UCB; Genomer 1251 [polyethylene glycol 400 diacrylate], Genomer 1343 [ethoxylated trimethylolpropane triacrylate], Genomer 1348 [glycerolpropoxy triacrylate], Genomer 1456 [polyether polyol tetraacrylate], and Diluent 02-645 [ethoxy ethoxy ethyl acrylate], all ex Rahn.

The monomer (c) is normally ethylenically unsaturated and should be insoluble in water. It is preferably an acrylate or methacrylate ester of a mono-, di-, tri-, tetra-, penta-, or hexa- hydric alcohol preferably having a molecular weight of less than 300. Examples of these acrylate esters include tripropylene glycol diacrylate, trimethylolpropane tri acrylate, butanediol diacrylate and hexanediol diacrylate, of which butanediol diacrylate and hexanediol diacrylate are most preferred. The proportion of the monomer (c) is also not critical, but it is preferably from 1 to 8% by weight, more preferably from 3 to 7% by weight, and most preferably from 5 to 6% by weight of the total composition.

Specific examples of commercially available monomers include: Laromer™ TPGDA [tripropylene glycol diacrylate], Laromer™ HDDA, [hexanediol diacrylate] all ex BASF, TMPTA-N [trimethylolpropane triacrylate] ex UCB, SR238 [hexanediol diacrylate], SR306 [tripropylene glycol diacrylate], SR351 [trimethylolpropane triacrylate], all ex Sartomer.

Alternative non-acrylated reactive monomers that may also be incorporated, which can be water soluble or insoluble, include acryloyl morpholine (Genomer ACMO ex Rahn), N-vinylcaprolactam (NVC ex BASF) and N-vinyl-N-methylacetamide (VIMA ex BASF).

The particulate electrically conductive material (d), which is sometimes referred to as a “filler” or “pigment”, is preferably a finely divided conductive metal or metal alloy, although any material of sufficiently high conductivity to achieve the required low resistivity in the cured product may be employed. Examples of suitable metals include silver, gold, copper, nickel, palladium and platinum. Conductive oxides of metals, such as silver oxide, may also be used. Mixtures, e.g. alloys, of metals for example alloys of any of the above metals with each other or with other metals, may also be used in order to obtain particular desired properties. It is also possible to use other forms of combinations of metals, for example particles of one metal coated with another metal, in order to benefit from the properties of the individual metals. For example, tin has a lower conductivity than silver, but is more malleable than silver. Where a combination of good conductivity and malleability is required, he conductive material could be composed of particles of tin coated with silver. However, the nature of the conductive material (d) will normally be decided primarily upon the conductivity and other properties required in the final cured product.

Conductive polymers, such as polyaniline, polypyrrole, polythiophenes, polyethylenedioxythiophene, and poly(p-phenylene vinylene), can be incorporated in the compositions of the present invention, but typically do not impart sufficient conductivity when used alone.

Conductive materials, such as carbon black or graphite, may also be used in the compositions of the present invention, but typically also do not impart sufficient conductivity when used alone.

The morphology of the particles of the conductive material will have a profound effect on the conductivity of the cured product. In general, as is well known, essentially spherical particles produce an ink which is less conductive than do plate-like or flake-like particles. However, plate-lilce or flake-like particles tend to block UV radiation and, when this is the radiation used for cure, it has been necessary, in the past, to compromise on the geometry of the particles in order to achieve adequate cure, as explained, for example in EP0653763. Since the present invention can use rather lower quantities of conductive material than do the prior art processes involving radiation cure, there is less inhibition of cure by the conductive material and so a better and quicker cure is achievable.

Normally the average particle sizes of the particulate metal conductive material can vary widely, but typically the size is in the region of from 1 micron to 50 microns, more preferably from 1 micron to 30 microns. Average particle size will have an effect on relative conductivity, for example if particle size is too small the resistivity of the composition may be too high. Large particle sizes may adversely influence the ability to apply the composition by the chosen application method to the substrate. For example, particles above 50 microns may clog and block the chosen screen printing mesh and so adversely affect the print performance.

Particulate silver is readily available from many commercial sources, and there is no particular restriction on its nature. As noted above, the silver may be powder or flake, or, if desired, a mixture, as described, for example, in U.S. Pat. No. 6,290,881. Examples of commercially available particulate silver which may be used in the present invention include: Silver Powder E, Silver Powder EG, Silver Powder EG-ED, Silver Powder C-ED, Silver Powder G-ED, Silver Powder J, Silver Flake #25, Silver Flake #1, and Silver Flake #7A, all available from Ferro Corporation, Germany; Protavic® AGP1208 Silver powder, Protavic® AGP1810 silver powder, Protavic® AGP3012 silver powder, Protavic® AGF2614 silver flake, all ex Protex International; and EG2205 Silver Flake, EG2351 Silver Powder, Cypher 88-110 Silver powder, all ex Johnson Matthey.

Examples of other commercially available conductive metal and metal alloy particulate materials include Silver coated Copper Powder #114, Silver coated copper powder #107, Silver Palladium powder 3027-2, Platinum Powder 7000-25, Platinum Powder #826, Gold Powder #1780, Gold Powder #2000, Palladium Powder 7100-10, all ex Ferro Corporation, Germany.

The amount of conductive material (d) included in the composition of the present invention will be largely determined by the need to achieve a level of conductivity in the cured product corresponding to a resistivity not greater than 1 ohm/square, as measured by ASTM test method F1896-98. In general, this will necessitate a level of conductive material of at least 50% by weight of the composition, more preferably at least 60%, and still more preferably at least 70% in the final cured and dried composition. In the prior art compositions, levels of conductive material of about 90% or even more are proposed in order to achieve the necessary conductivity, and these can seriously impair cure. In the present invention, such high levels are unnecessary, and so UV curing can, if desired, be used, with good results. In the present invention, the maximum level of conductive material is primarily determined by the need to ensure that the composition of the present invention is flowable and that there is sufficient of the binder present that the cured coating maintains its structural integrity. Thus, the ratio of the particulate conductive particles to non volatile binder [e.g. components (a), (b) and (c)] content should preferably be at least 2:1, more preferably at least 3:1, and most preferably greater than 3:1 by weight. However, ratios greater than about 6:1, depending on the nature of the materials, may make the ink difficult to apply and so should normally be avoided. In general, we prefer to include no more than 90% by weight of the conductive material, based on the weight of the total uncured composition, and more preferably no more than 85% by weight, most preferably no more than 80% by weight. Thus, the preferred ranges are from 30 to 90%, more preferably from 35 to 85%, and most preferably from 40 to 80%, by weight of the total composition.

In any event, the amount and dimensions of the conductive particles (d) should be so chosen as to ensure that the cured composition has a resistivity no greater than 1 ohm/square, and preferably no greater than 10⁻¹ ohm/square, and still more preferably no greater than 10⁻² ohm/square, as measured by the method defined by ASTM test method F1896-98, “Test Method For Determining The Electrical Resistivity Of A Printed Conductive Material”. When using the amounts of conductive particles (d) suggested above, little difficulty should be experienced in achieving these levels.

Where the composition is to be cured by exposure to UV radiation, it will normally contain a photoinitiator, as is well known in the art. The nature of the photoinitiator is not critical to the present invention, and any photoinitiator known for use with the monomers, oligomers and prepolymers described above may equally be used in the present invention. The photoinitiator is preferably chosen from the types known as Norrish types I and II, and is preferably capable of initiating the polymerisation of the components when exposed to ultraviolet light of wavelengths between 200 and 450 nanometres. Examples of suitable photoinitiators include: thioxanthone or a substituted thioxanthone, such as isopropyl thioxanthone (e.g. Speedcure™ ITX ex Lambson or Darocur™ ITX ex Ciba Geigy) and 2-chlorothioxanthone (e.g. Kaycure™ CTX ex Nippon Kayaku); benzophenone (e.g. Esacure™ Benzophenone Flake ex Lamberti) or a substituted benzophenone, such as a eutectic mixture of 2,4,6-trimethylbenzophenone and 4 methyl benzophenone (e.g. Esacure™ TZT ex Lamberti); 1-hydroxycyclohexyl phenyl ketone (e.g. Irgacure™ 184 ex Ciba Geigy); 2,2-dimethoxy-1,2-diphenylethan-1-one (e.g. Irgacure™ 651 ex Ciba Geigy); 2-methyl-1-(4-methylthiophenyl)-2-morpholinopropan-1-one (e.g. Irgacure™ 907 ex Ciba Geigy); 2-hydroxy-2-methylpropiophenone (e.g. Darocur™ 1173 ex Ciba Geigy); oligo{2-hydroxy-2-methyl-1-[4-(1-methylvinyl)phenyl]propane} (e.g. Esacure™ KIP100 ex Lamberti); 2-hydroxy-2-methyl-1-phenyl propan-lone (e.g. Esacure™ KL200 ex Lamberti); benzyl methyl ketal; 2-benzyl-2-dimethylamino-4-morpholinobutyrophenone (e.g. Irgacure™ 369 ex Ciba Geigy); phenyl bis(2,4,6-trimethylbenzoyl)phosphine oxide (e.g. Irgacure™ 819 ex Ciba Geigy); diphenyl (2,4,6-trimethylbenzoyl)phosphine oxide (e.g. Darocur™ TPO ex Ciba Geigy or Lucerin™ TPO ex BASF); ethyl phenyl (2,4,6-trimethylbenzoyl) phosphinate (e.g. Darocur™ TPO-L ex Ciba Geigy or Lucerin™ TPO-L ex BASF). Mixtures of photoinitiators may be used, if desired. The proportion by weight of initiator is not critical or unique to the present invention, and is preferably from 0.5 to 10%, more preferably from 1 to 5%.

However, if other forms of radiation are used to secure cure of the composition of the present invention, for example an electron beam, then a photoinitiator may not be necessary. These matters are standard and well known to those skilled in the art.

The amount of water in the composition will be determined, at least in part, by the desire to produce a sufficiently flowable composition that it may be used in a high speed printing machine. For this purpose, it is preferred that the viscosity should not exceed 5,000 mPas at 25° C., preferably that it should not exceed 4,000 mPas at 25° C. In practice, the lower limit of the viscosity will normally be 500 mPas at 25°. In order to achieve these values, the amount of water in the composition is preferably in the region of from 1 to 60%, more preferably from 1 to 40%, even more preferably from 1 to 30% by weight of the total uncured composition.

The amount of water will also affect the degree of shrinkage of the printed or coated composition when curing, and hence will effect the degree of compaction of the conductive particulate material, thereby influencing the final cured film's conductivity.

The composition of the present invention may be formulated as a printing ink, varnish, adhesive or any other coating composition which is intended to be cured by irradiation, whether by ultraviolet or electron beam. Such compositions will normally contain at least the components specified above, but may also include other additives well known to those skilled in the art, for example, defoaming agents/wetting agents, waxes, flow aids and, if desired, a pigment or other colorant.

The defoamer/wetting agent could typically be any one of a group of modified polysiloxanes. This can be combined, if necessary, with a typical mineral oil derivative and/or a polyacrylate to provide the desired combination of levelling and defoaming properties during application to the substrate.

If desired, inert or passive resins, such as acrylics, styrene acrylates, polyester or celluloses, may be included in the composition in small amounts, in order to improve adhesion and or intercoat adhesion.

Fillers, such as calcium carbonate, china clay, aluminium hydrate, barium sulphate, aluminium silicate and silica, and waxes, such as polyethylene or polytetrafluoroethylene, may be incorporated to modify the physical properties of the composition. However, it should be appreciated that these will adversely affect the conductivity of the system and, therefore, if added, should preferably be present in small amounts.

Small amounts of humectants or coalescing materials may also be incorporated if required to control the evaporation or drying of the water content.

A preferred composition of the present invention comprises:
(a) from 2 to 15%, more preferably from 4 to 14%, by weight of a water-soluble or water-dispersible oligomer or prepolymer capable of being polymerised by radiation,
(b) from 2 to 10%, more preferably from 2 to 9%, by weight of a water-soluble monomer capableof being polymerised by radiation,
(c) from 1 to 8% by weight, more preferably from 3 to 7% by weight, of a water-insoluble monomer capable of being polymerised by radiation,
(d) sufficient of a particulate electrically conductive material that the ratio of said electrically conductive material (d) to the components (a), (b) and (c) is at least 2:1, and more preferably at least 3:1 by weight, and most preferably no greater than 6:1,
(e) from 1 to 60%, more preferably from 1 to 40%, by weight of water as a non-reactive diluent, and
(f) optionally from 0.5 to 10%, more preferably from 1 to 5%, most preferably from 1 to 30%, by weight of a photoinitiator,
   the composition preferably having a viscosity of from 5,000 mPas to 500 mPas poise at 25° C.

A typical composition of the present invention is as follows:

| Component: | % by weight |
|---|---|
| Prepolymer/Oligomer | 6.9 |
| Water soluble/dispersible monomer | 3.1 |
| Water insoluble monomer | 5.9 |
| Photoinitiator | 1.8 |
| Defoamer/wetting agent | 0.2 |
| Water | 7.1 |
| Pigment | 75.0 |
| Total: | 100.0 |

The compositions of the present invention may be applied by any well known printing or coating technique, for example screen, rotary screen, gravure or flexographic printing.

The invention is further illustrated by the following non-limiting Example.

### EXAMPLE 1

The following screen ink composition was prepared by first mixing the liquid components using a high speed disc impeller mixer. Once the composition was homogenous, the silver conductive powder was slowly added part wise. The composition was then mixed until full wetting of the pigment was achieved. The composition was then passed over a triple roll mill loosely.

| Component: | % by weight |
|---|---|
| Ebecryl ™ 2003 ex UCB Chemicals | 6.9 |
| SR344 ™ ex Sartomer (Cray Valley) | 3.1 |
| HDDA ex UCB Chemicals | 5.9 |
| Lucerin ™ TPO ex BASF | 0.9 |
| Darocur ™ 1173 ex Ciba Geigy | 0.9 |
| Teofoamex ™ 900 ex Degussa Tego Chemie | 0.2 |
| Deionised Water | 7.1 |
| Silver Powder #311 ex Ferro Corporation | 75.0 |
| Total: | 100.0 |

The resultant ink was then tested by printing through a 120 mesh onto polycarbonate, print receptive polyester, and coated paper substrates, and cured using medium pressure mercury lamps (80Wcm-1). The prints were examined for adhesion, flexibility and print definition, as well as for conductivity as determined by ASTM test method F1896-98.

The prints were found to have excellent adhesion, flexibility and print definition. Conductivity was also found to be improved compared to conventional commercially available UV cure products.

1. An energy-curable coating composition comprising a water-soluble or water-dispersible binder capable of being polymerised by exposure to a source of radiation, a particulate electrically conductive material, and water as a non-reactive diluent, and, optionally, a photoinitiator, the composition, when cured, having a resistivity no greater than 1 ohm/square, as measured by ASTM F1896-98.

2. A composition according to claim 1, in which the binder comprises at least a polymerisable monomer, prepolymer or oligomer capable of polymerisation by radiation and including at least one component which is water-soluble or water-dispersible.

3. A composition according to claim 2, in which the binder comprises a water-soluble or water-dispersible oligomer or prepolymer capable of being polymerised by radiation or a water-soluble monomer capable of being polymerised by radiation, or both and optionally a water-insoluble monomer capable of being polymerised by radiation.

4. A composition according to claim 3, in which the binder comprises:
(a) a water-soluble or water-dispersible oligomer or prepolymer capable of being polymerised by radiation,
(b) a water-soluble monomer capable of being polymerised by radiation,
(c) a water-insoluble monomer capable of being polymerised by radiation,
(d) a particulate electrically conductive material,
(e) water as a solvent or dispersant, and
(f) optionally a photoinitiator.

5. A composition according to claim 1, in which the binder comprises a water- soluble or water-dispersible urethane, polyester or epoxy resin containing acrylate ester groups or residues or both.

6. A composition according to claim 4, in which said water-soluble or water-dispersible oligomer or prepolymer (a) is a water-soluble or water-dispersible urethane, polyester or epoxy resin containing acrylate ester groups or residues or both.

7. A composition according to claim 1, in which the binder comprises an ester of acrylic or methacrylic acid with polyethylene glycol or with a mono-, di-, tri-, or tetra-hydric alcohol derived by ethoxylating a mono-, di-, tri-, or tetra-hydric aliphatic alcohol of molecular weight less than 200 with ethylene oxide.

8. A composition according to claim 4, in which said water-soluble monomer (b) is an ester of acrylic or methacrylic acid with polyethylene glycol or with a mono-, di-, tri-, or tetra-hydric alcohol derived by ethoxylating a mono-, di-, tri-, or tetra-hydric aliphatic alcohol of molecular weight less than 200 with ethylene oxide.

9. A composition according to claim 1, in which the binder includes an acrylate or methacrylate ester of a mono-, di-, tri-, tetra-, penta-, or hexa-hydric alcohol preferably having a molecular weight of less than 300.

10. A composition according to claim 4, in which said water-insoluble monomer (c) is an acrylate or methacrylate ester of a mono-, di-, tri-, tetra-, penta-, or hexa-hydric alcohol preferably having a molecular weight of less than 300.

11. A composition according to claim 1, in which said electrically conductive material is a metal or metal oxide.

12. A composition according to claim 11, in which said metal is silver, copper, nickel, tin, or platinum, or a mixture or alloy including at least one of these metals.

13. A composition according to claim 4, in which said water-soluble or water-dispersible oligomer or prepolymer (a) is present in an amount of from 2 to 15% by weight of the total composition.

14. A composition according to claim 4, in which said water-soluble monomer (b) is present in an amount of from 2 to 10% by weight of the total composition.

15. A composition according to claim 4, in which said water-insoluble monomer (c) is present in an amount of from 1 to 8% by weight of the total composition.

16. A composition according to claim 4, in which said conductive material (d) is present in an amount such that the weight ratio of (d) to (a) plus (b) plus (c) is at least 2:1.

17. A composition according to claim 16, in which said ratio is at least 3:1.

18. A composition according to claim 17, in which said ratio is no greater than 6:1.

19. A composition according to claim 1, in which said conductive material is present in an amount of from 30 to 90% by weight of the total composition.

20. A composition according to claim 1, in which said conductive material is present in an amount of at least 35% by weight of the total composition.

21. A composition according to claim 20, in which said conductive material is present in an amount of at least 40% by weight of the total composition.

22. A composition according to claim 1, in which said water is present in an amount of from 1 to 60% of the total composition.

23. A composition according to claim 22, in which said water is present in an amount of from 1 to 40% of the total composition.

24. A composition comprising:
(a) from 2 to 15% by weight of a water-soluble or water-dispersible oligomer or prepolymer capable of being polymerised by radiation,
(b) from 2 to 10%, more preferably from 2 to 9%, by weight of a water-soluble monomer capable of being polymerised by radiation,
(c) from 1 to 8% by weight of a water-insoluble monomer capable of being polymerised by radiation,
(d) sufficient of a particulate electrically conductive material that the ratio of said electrically conductive material to components (a), (b) and (c) is at least 2:1
(e) from 1 to 60% by weight of water as a non reactive diluent, and
(f) optionally from 0.5 to 10% by weight of a photoinitiator, the composition, when cured, having a resistivity no greater than 1 ohm/square, as measured by ASTM F1896-98.

25. A composition according to claim 1, having, when cured, a resistivity no greater than 10⁻¹ ohm/square, as measured by ASTM F1896-98.

26. A composition according to claim 25, having, when cured, a resistivity no greater than 10⁻² ohm/square, as measured by ASTM F1896-98.

27. A process for producing a printed electrically conductive coating, in which a composition according to claim 1 is printed onto a substrate, and is then energy cured by exposure to a source of actinic radiation.

28. A process according to claim 27, in which said radiation is ultraviolet or electron beam.

28. A composition comprising:
(a) from 4 to 14% by weight of a water-soluble or water-dispersible oligomer or prepolymer capable of being polymerised by radiation,
(b) from 2 to 9%, by weight of a water-soluble monomer capable of being polymerised by radiation,
(c) from 3 to 7% by weight of a water-insoluble monomer capable of being polymerised by radiation,
(d) sufficient of a particulate electrically conductive material that the ratio of said electrically conductive material to components (a), (b) and (c) is at least 3:1
(e) from 1 to 40% by weight of water as a non reactive diluent, and
(f) from 1 to 5% by weight of a photoinitiator, the composition, when cured, having a resistivity no greater than 10⁻² ohm/square, as measured by ASTM F1896-98.
